(19) United States
(12) Patent Application Publication
(10) Pub. No.: US 2008/0155482 A1
(43) Pub. Date: Jun. 26, 2008

(54) AUTOMATED OPTIMIZATION OF VLSI LAYOUTS FOR REGULARITY

(75) Inventors: Dureseti Chidambarrao, Weston, CT (US); James A. Culp, Downingtown, PA (US); Jason D. Hibbeler, Williston, VT (US)

Correspondence Address: WOOD, HERRON & EVANS, LLP (IBM-BUR), 2700 CAREW TOWER, 441 VINE STREET, CINCINNATI, OH, 45202, US

(73) Assignee: INTERNATIONAL BUSINESS MACHINES CORPORATION, Armonk, NY (US)

(21) Appl. No.: 11/614,260

(22) Filed: Dec. 21, 2006

(51) Int. Cl. G06F 17/50

(52) U.S. Cl. 716/2

(57) ABSTRACT

VLSI lithographic fidelity is improved via reducing the pattern space of difficult patterns or structures in a design layout for an integrated circuit design, and thereby increasing the regularity of the design, by converting patterns or structures that are similar but not identical to one another into a smaller set of canonical geometric configurations. By doing so, lithographic processing can be tuned to handle the smaller set of configurations more accurately and efficiently.

### FIELD OF THE INVENTION

The invention is generally directed to the design and fabrication of semiconductor integrated circuits.

### BACKGROUND OF THE INVENTION

The shrinking dimensions of deep-submicron VLSI typically require extremely precise and time-consuming post-design lithographic processing in order to achieve correct on-wafer geometric structures. Wafer features in fact have shrunken below the resolution of the tooling used to create the lithographic masks that are used to form the features on a wafer, resulting in a significant increase in the processing necessary to create photolithographic masks. This processing is known as optical proximity correction (OPC). As a consequence of these shrinking dimensions, certain problems associated with the lithographic process, such as line-end foreshortening and corner rounding, have become unavoidable in VLSI manufacture.

Many of the issues inherent in photolithography can be addressed during the lithographic process, principally through “tuning” the process and the associated OPC. For example, parameters of the process such as focus and dose can be adjusted to optimize the process to address certain types of issues, and the OPC is then adjusted to take the modified process parameters into account. However, corrections that are performed to address some issues (e.g., bridging/shorts) can exacerbate other issues (e.g., pinching/opens), and as a result, careful tradeoffs often must be made when attempting to tune the lithographic process. Importantly, it has been found that similar but slightly different variations of the same geometrical configuration foster lithographic infidelity and hamper a robust and efficient treatment of challenging geometries.

One technique for improving lithographic fidelity is by requiring layouts to be built from a small number of repeated building-block structures (as with field-programmable gate arrays (FPGA's)). Another technique involves the use of library elements that have been separately designed and optimized. None of these approaches, however, provides a complete solution, as some degree of custom layout is typically still required once building blocks or library elements have been put in place, resulting in areas of a design that are problematic from a lithographic fidelity standpoint. In addition, in many high performance or sensitive designs, substantial custom layout may be required to tune a design to meet its functional design goals, limiting the amount of standardized elements that can be used in the design. Still further, in the case of a contract semiconductor fabricator, where design layouts may be created by a customer and provided in a finalized form to the fabricator, the ability for the fabricator to tune a design to address lithographic fidelity may be limited.

Therefore, a substantial need continues to exist in the art for a manner of improving lithographic fidelity in the design layouts for integrated circuit designs.

### SUMMARY OF THE INVENTION

The invention addresses these and other problems associated with the prior art by attempting to improve lithographic fidelity via reducing the pattern space of difficult patterns or structures in a design layout for an integrated circuit design, and thereby increasing the regularity of the design, by converting patterns or structures that are similar but not identical to one another into a smaller set of canonical geometric configurations. By doing so, lithographic processing can be tuned to handle the smaller set of configurations more accurately and efficiently.

Consistent with one aspect of the invention, an integrated circuit design is optimized by identifying a set of lithographically challenging structures in a design layout, and, for each structure in the set, selecting a canonical representation for such structure and tuning lithographic processing for the selected canonical representation. In addition, for each structure in the set, a plurality of variants of such structure are identified via pattern matching, and optimization constraints are generated to convert each variant to match the selected canonical representation. The design layout is then optimized using the generated optimization constraints to convert the variants to match the selected canonical representations and thereby increase the regularity of the design layout.

These and other advantages and features, which characterize the invention, are set forth in the claims annexed hereto and forming a further part hereof. However, for a better understanding of the invention, and of the advantages and objectives attained through its use, reference should be made to the Drawings, and to the accompanying descriptive matter, in which there is described exemplary embodiments of the invention.

### BRIEF DESCRIPTION OF THE DRAWINGS

FIG. 1 is a block diagram of a computer suitable for use in optimizing an integrated circuit design for regularity in a manner consistent with the invention.

FIG. 2 is a flowchart of a design optimization process consistent with the invention.

FIGS. 3A-3C are top plan views of three exemplary variations of a lithographically challenging structure in an integrated circuit design.

### DETAILED DESCRIPTION

The embodiments described hereinafter improve lithographic fidelity via reducing the pattern space of difficult patterns or structures in a design layout for an integrated circuit design. Among other benefits, the embodiments herein are suitable for use with existing design layouts or physical designs, as well as design layouts incorporating substantial custom (e.g., non-building block or non-library element) features. The pattern space of difficult patterns or structures is reduced by converting similar patterns to selected canonical geometric configurations, such that lithographic processing can then be tuned to handle a smaller set of patterns.

In particular, embodiments consistent with the invention operate upon an existing VLSI physical design, or design layout, and identify therein a set of lithographically challenging configurations or patterns. For each such configuration or pattern, a canonical geometric configuration is selected, and the lithographic process is tuned to handle that selected configuration or pattern. Then, for each selected, or target, configuration or pattern, pattern matching is used to locate other patterns in the design layout that are similar thereto, and optimization constraints and objectives are generated to force each similar pattern to match the target pattern. Once the optimization constraints and objectives are generated the design layout may then be optimized, resulting in an increase in the regularity of the design layout, and a design that is more amenable to subsequent lithographic processing.

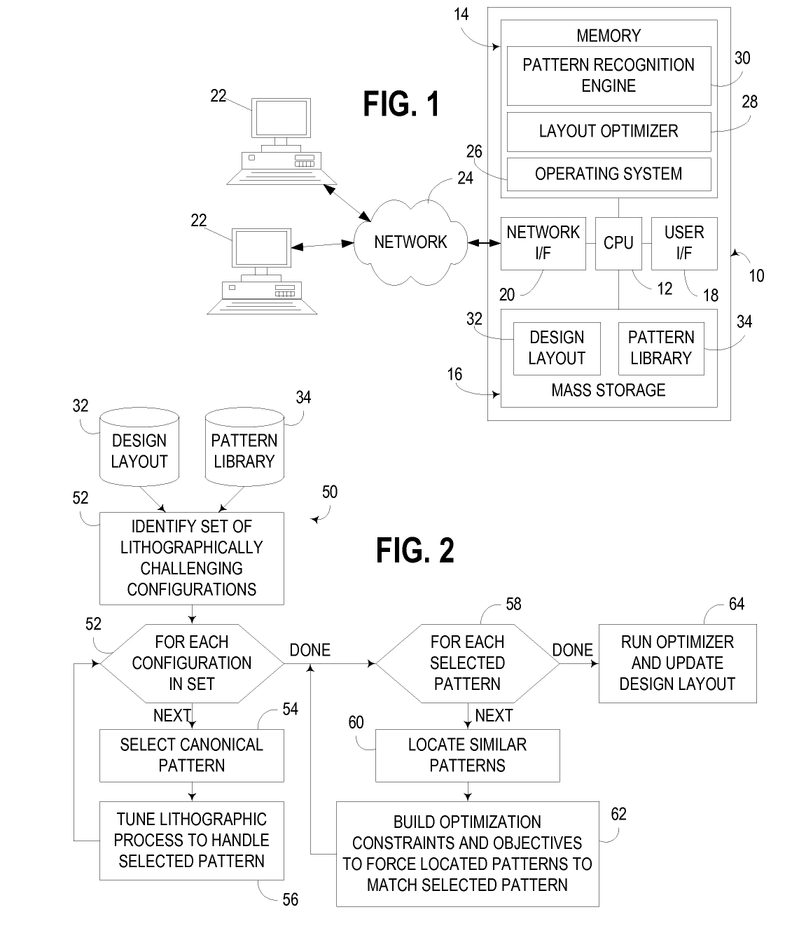

Turning now to the Drawings, wherein like numbers denote like parts throughout the several views, FIG. 1 illustrates an exemplary hardware and software environment for an apparatus 10 suitable for use in connection with optimizing an integrated circuit design for regularity in a manner consistent with the invention. For the purposes of the invention, apparatus 10 may represent practically any type of computer, computer system or other programmable electronic device, and may be implemented using one or more networked computers, e.g., in a cluster or other distributed computing system. Apparatus 10 will hereinafter also be referred to as a “computer,” although it should be appreciated that the term “apparatus” may also include other suitable programmable electronic devices consistent with the invention.

Computer 10 typically includes a central processing unit (CPU) 12 including one or more microprocessors coupled to a memory 14, along with several different types of peripheral devices, e.g., a mass storage device 16, a user interface 18 (including, for example, user input devices and a display), and a network interface 20 (for use in communicating with one or more other computers 22 over a network 24).

Computer 10 operates under the control of an operating system 26, and executes or otherwise relies upon various computer software applications, components, programs, objects, modules, data structures, etc., including, for example, a layout optimizer 28 and pattern recognition engine 30 for use in connection with the optimization process described herein. Moreover, various applications, components, programs, objects, modules, etc. may also execute on one or more processors in another computer coupled to computer 10 via a network, e.g., in a distributed or client-server computing environment.

In general, the routines executed to implement the embodiments of the invention, whether implemented as part of an operating system or a specific application, component, program, object, module or sequence of instructions, or even a subset thereof, will be referred to herein as “computer program code,” or simply “program code.” Program code typically comprises one or more instructions that are resident at various times in various memory and storage devices in a computer, and that, when read and executed by one or more processors in a computer, cause that computer to perform the steps necessary to execute steps or elements embodying the various aspects of the invention. Moreover, while the invention has and hereinafter will be described in the context of fully functioning computers and computer systems, those skilled in the art will appreciate that the various embodiments of the invention are capable of being distributed as a program product in a variety of forms, and that the invention applies equally regardless of the particular type of computer readable media used to actually carry out the distribution. Examples of computer readable media include but are not limited to physical, recordable type media such as volatile and non-volatile memory devices, floppy and other removable disks, hard disk drives, magnetic tape, optical disks (e.g., CD-ROMs, DVDs, etc.), among others, and transmission type media such as digital and analog communication links.

Those skilled in the art will recognize that the exemplary environment illustrated in FIG. 1 is not intended to limit the present invention. Indeed, those skilled in the art will recognize that other alternative hardware and/or software environments may be used without departing from the scope of the invention.

One implementation of an optimization process consistent with the invention is illustrated in further detail at 50 in FIG. 2. In this implementation, layout optimizer 28 is configured to optimize a design layout 32 with the assistance of a pattern recognition engine 30. Engine 30 relies on a pattern library 34 that includes a set of potential lithographically challenging patterns that may be present within design layout 32, and for which it may be desirable to search for to identify potential areas for improving the regularity of the design layout.

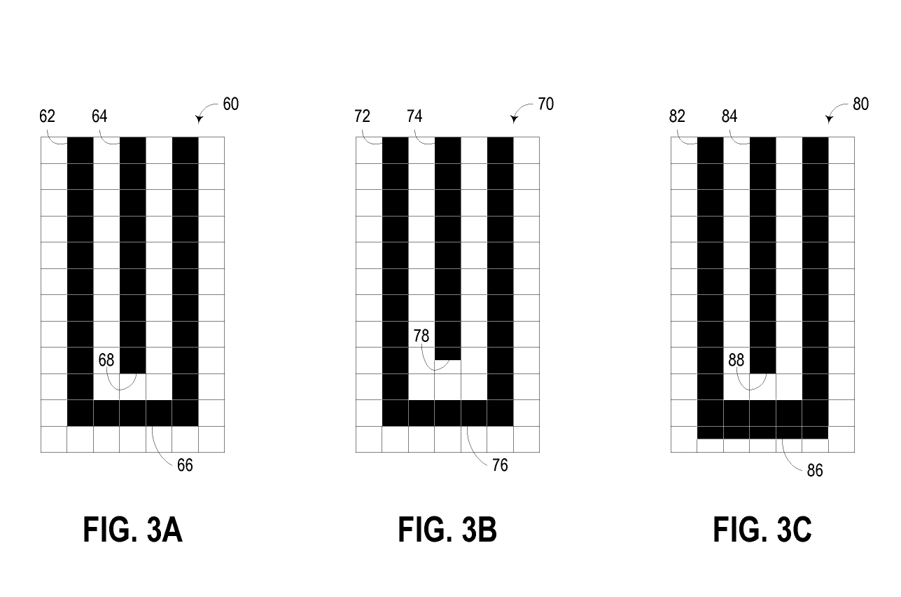

Process 50 begins in block 52 by analyzing the design layout to identify a set of lithographically challenging configurations in the design layout, i.e., geometric configurations that are anticipated to be difficult to print accurately due to tight dimensions and/or undesired lithographic effects (for example, the “line-end-and-U” configuration discussed below in connection with FIGS. 3A-3C). Block 52 may be implemented, for example, by searching the design layout for occurrences of patterns that are the same or similar to the set of patterns in library 34. The patterns in the library may be developed over time based upon empirical observation from past design layouts.

As one potential implementation, the identification of lithographically challenging configurations may be performed by a design rule checker (DRC) that is programmed to find and count instances of similar structures. One of ordinary skill in the art will appreciate that such checking would not require sophisticated pattern matching, and would be within the realm of standard design-rule checking.

Next, for each identified configuration in the set (block 52), a canonical pattern or representation is selected in block 54 and the lithographic processing is tuned to handle the selected pattern in block 56.

Once canonical patterns or representations have been selected and the lithographic processing has been tuned to handle these target patterns, for each target or selected pattern (block 58), similar patterns, or variants, are located in the design layout in block 60. A pattern matching engine, e.g., a design rule checker, may locate such patterns in a similar manner to the manner in which lithographically challenging configurations are identified. A design rule checker may be configured, for example, to search for patterns with matches within certain specific tolerances to each selected canonical representation, in a similar manner to that for which a design rule checker uses to validate compliance of a design layout to design rules. Each similar pattern or variant is desirably marked with shapes showing the relationship of the canonical pattern to the similar pattern, so that the marker shapes can be used to guide subsequent layout optimization.

Next, in block 62 optimization constraints and objectives (hereinafter collectively referred to as optimization constraints) are constructed to force the located similar patterns or variants to match the selected canonical representation. For example, layout optimizer 28, which may be implemented, for example, as a scanline-driven layout-optimization application, may be used to build optimization constraints that attempt to force all the similar variants for a given canonical representation to match that canonical representation. This optimization is also typically performed in a manner that ensures that ground rules are obeyed and electrical connectivity is maintained.

Once the optimization constraints have been constructed to convert all of the variants to their respective canonical representations, the constraints are used by the layout optimizer in block 64 to optimize the design layout and convert the variants to the canonical representations, and update the design layout accordingly. The result is a design layout having a smaller set of patterns, for which the lithography process can be better tuned.

As a further example of the operation of the optimization process described above, FIGS. 3A-3C illustrate three exemplary variations of a lithographically challenging structure that might be found in the design layout for an integrated circuit design, namely an arrangement referred to as a “line-end-and-U” structure.

FIG. 3A illustrates a first variant 60 including a U-shaped feature 62 that partially circumscribes a line 64. U-shaped feature 62 includes a pair of legs joined by a transverse member 66 that joins the legs proximate an end 68 of line 64. A second variant 70, illustrated in FIG. 3B, is similar to variant 60, including a U-shaped feature 72 that partially circumscribes a line 74, with the U-shaped feature 72 including a pair of legs joined by a transverse member 66 disposed proximate an end 78 of line 74. Likewise, a third variant 80, illustrated in FIG. 3C, is similar to variants 60 and 70, including a U-shaped feature 82 that partially circumscribes a line 84, with the U-shaped feature 82 including a pair of legs joined by a transverse member 86 disposed proximate an end 88 of line 84. Variant 70 differs from variant 60 by virtue of a larger space between transverse member 76 and line end 78, while variant 80 differs from variant 60 by virtue of a thicker transverse member 86.

With the lithographic processing tuned to the dimensions of variant 60 of FIG. 3A, it has been found that variants 70 and 80 may be susceptible to pinching or bridging due to the slight variations in line widths and spacings at the interactions of the line ends and U-shapes. Consistent with the invention, however, variants 60, 70 and 80 may be identified as being variants of a lithographically challenging configuration, and one of the variants, e.g., variant 60, may be selected as the canonical representation for that family of variants. The lithographic processing may be tuned for variant 60, and pattern matching may then be used to identify variants 70 and 80 as being similar patterns to variant 60. Optimization constraints may then be generated to force variants 70 and 80 to be converted to the canonical form represented by variant 60 during optimization. As a result, after optimization all three variants 60, 70 and 80 take the form of variant 60. With the lithographic processing tuned to handle variant 60, therefore, all three instances of the structure will be printed with the lithographic processing specifically tuned for optimal printing. Consequently, the set of patterns in the design layout is reduced and the regularity of the overall design is enhanced.

Various modifications may be made to the illustrated embodiments without departing from the spirit and scope of the invention. Therefore, the invention lies in the claims hereinafter appended.

What is claimed is:

1. A method of optimizing an integrated circuit design, the method comprising:
identifying a set of lithographically challenging structures in a design layout;
for each structure in the set, selecting a canonical representation for such structure and tuning lithographic processing for the selected canonical representation;
for each structure in the set, identifying a plurality of variants of such structure via pattern matching and generating optimization constraints to convert each variant to match the selected canonical representation; and
optimizing the design layout using the generated optimization constraints to convert the variants to match the selected canonical representations and thereby increase the regularity of the design layout.

2. The method of claim 1, wherein identifying the plurality of variants of each lithographically challenging structure is performed using a design rule checker.

3. The method of claim 1, wherein optimizing the design layout is performed using a layout optimizer.

4. The method of claim 1, wherein the set of lithographically challenging structures includes a line-end-and-U structure.

5. An apparatus, comprising:
a memory within which is stored a design layout for an integrated circuit design, the design layout including a set of lithographically challenging structures and a plurality of variants of each of the lithographically challenging structures;
at least one processor; and
program code configured to be executed by the at least one processor to optimize the integrated circuit design, the program code configured to, for each lithographically challenging structure, identify the plurality of variants of such structure in the design layout via pattern matching and generate optimization constraints to convert each variant to match a selected canonical representation for such structure for which lithographic processing has been tuned, the program code further configured to optimize the design layout using the generated optimization constraints to convert the variants to match the selected canonical representations and thereby increase the regularity of the design layout.

6. The apparatus of claim 5, wherein the program code is further configured to identify the set of lithographically challenging structures in the design layout.

7. The apparatus of claim 6, wherein the program code comprises a design rule checker configured to identify the set of lithographically challenging structures and to identify the plurality of variants of each such structure.

8. The apparatus of claim 5, wherein the program code comprises a layout optimizer configured to optimize the design layout using the generated optimization constraints.

9. The apparatus of claim 5, wherein the set of lithographically challenging structures includes a line-end-and-U structure.
